(19) United States
(12) Patent Application Publication
(10) Pub. No.: US 2007/0176081 A1
(43) Pub. Date: Aug. 2, 2007

(54) Lens for Ambient Light Sensor

(76) Inventor: Robert S. Stricklin, Richardson, TX (US)

Correspondence Address: LOCKE LIDDELL & SAPP LLP;ATTN: DOCKETING DEPT., 2200 ROSS AVENUE, SUITE 2200, DALLAS, TX, 75201-6776, US

(21) Appl. No.: 11/668,517

(22) Filed: Jan. 30, 2007

Related U.S. Application Data
(60) Provisional application No. 60/764,198, filed on Feb. 1, 2006.

(51) Int. Cl. H05B 37/02; G01J 1/44

(52) U.S. Cl. 250/214 AL

(57) ABSTRACT

A lens assembly for use with an ambient light sensor includes a housing having a top surface and including an aperture. An ambient light sensor is mounted within the housing adjacent to the housing aperture. A lens is mounted within the housing aperture for collecting ambient light impinging on the housing and for transmitting the collected light to the ambient light sensor, such that the transmitted light is directed over an area on the ambient light sensor that is greater than the area of the housing aperture.

### RELATED APPLICATION

This application claims the benefit of U.S. Provisional Patent Application Ser. No. 60/764,198 filed Feb. 1, 2006 and entitled “Lens for Ambient Light Sensor.”

### TECHNICAL FIELD OF THE INVENTION

The present invention relates to ambient light sensor assemblies, and more particularly to a lens for an ambient light sensor.

### BACKGROUND OF THE INVENTION

Ambient light sensors are utilized to control the brightness of displays used with portable electronic devices such as, for example, lap-top computers, notebooks, tablets, flat-panel televisions, cell phones and digital cameras. The ambient light sensor obtains a sample of the ambient light present in the environment in which the electronic device is utilized through an aperture or transparent region in the device case or cover. The light transmitting region is made as small as possible to make the area as inconspicuous and non-obtrusive as possible. The placement of the ambient light sensor in the electronic device varies due to the size of the electronic device such as for cell phones, thin packaging is utilized and ambient light sensor placement is variable based on the assembly of the electronic device. This variation is due to a tolerance stack up between the electronic device cover, printed circuit board, and other components, which causes the ambient light sensor sampling aperture to grow to an unacceptable size.

A need has thus arisen for a lens assembly for use with an ambient light sensor which accommodates electronic devices having a thin package and which samples ambient light through a small aperture.

### SUMMARY OF THE INVENTION

In accordance with the present invention, a lens assembly for use with an ambient light sensor includes a housing having a top surface and including an aperture. An ambient light sensor is mounted within the housing adjacent to the housing aperture. A lens is mounted within the housing aperture for collecting ambient light impinging on the housing top surface and for transmitting the collected light to the ambient light sensor, such that the transmitted light is directed over an area on the ambient light sensor that is greater than the area of the housing aperture.

### BRIEF DESCRIPTION OF THE DRAWING

For a more complete understanding of the present invention and for further advantages thereof, reference is now made to the following Description of the Preferred Embodiments taken in conjunction with the accompanying Drawings in which:

FIG. 1 is a perspective view of a portable electronic device utilizing the present lens assembly;

FIG. 2 is an enlarged perspective view of a portion of the portable electronic device shown in FIG. 1 illustrating the use of a plano-convex lens with the present lens assembly;

FIG. 3 is an enlarged perspective view of a portion of the portable electronic device shown in FIG. 1 utilizing the use of a Fresnel lens with the present lens assembly;

FIG. 4 is a perspective view of the plano-convex lens illustrated in FIG. 2;

FIG. 5 is a side-elevational view of the plano-convex lens illustrated in FIG. 4;

FIG. 6 is a perspective view of the Fresnel lens illustrated in FIG. 3; and

FIG. 7 is a side-elevational view of the Fresnel lens illustrated in FIG. 6.

### DESCRIPTION OF THE PREFERRED EMBODIMENTS

Referring to FIG. 1, the present lens assembly for use with an ambient light sensor is illustrated, and is generally identified by the numeral 10. Lens assembly 10 is utilized with a portable electronic device, such as, for example, a lap-top computer, generally identified by the numeral 12. Portable electronic devices also include, for example, notebooks, tablets, flat-panel televisions, cell phones, and digital cameras which include a display where brightness is controlled by ambient light impinging on the device.

Portable electronic device 12 includes a housing 14 having a top surface 16. Top surface 16 of housing 14 includes an aperture 18.

An ambient light sensor 20 is mounted within housing 14 and is spaced apart from top surface 16 of housing 14. Ambient light sensor 20 is mounted to a printed circuit board 22 positioned within housing 14. Ambient light sensor 20 includes a surface 24 for receiving optical energy. Ambient light sensor 20 may include, for example, a light-to-digital converter model No. TSL 2440 T manufactured and sold by Texas Advanced Optoelectronic Solutions, Inc. of Plano, Tex.

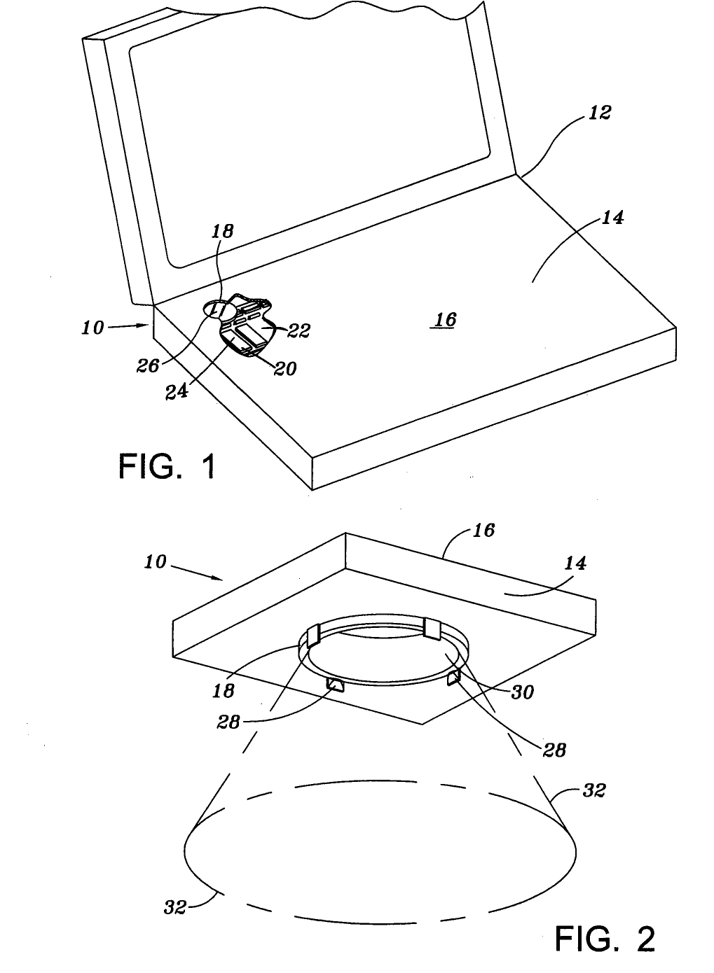

In accordance with the present invention, lens assembly 10 includes a lens 26 which is mounted within aperture 18 of housing 14. Lens 26 is mounted below the top surface 16 of housing 14. Lens 26 is molded from optically transparent plastic material, and may include a filter for blocking infrared wavelengths of light which may result in erroneous sensor 20 operation when measuring ambient light. Alternatively, lens 26 may be molded using a thermoset plastic material that blocks infrared wavelengths. Lens 26 is mounted within aperture 18 utilizing an interlocking clip 28 (FIGS. 2 and 3).

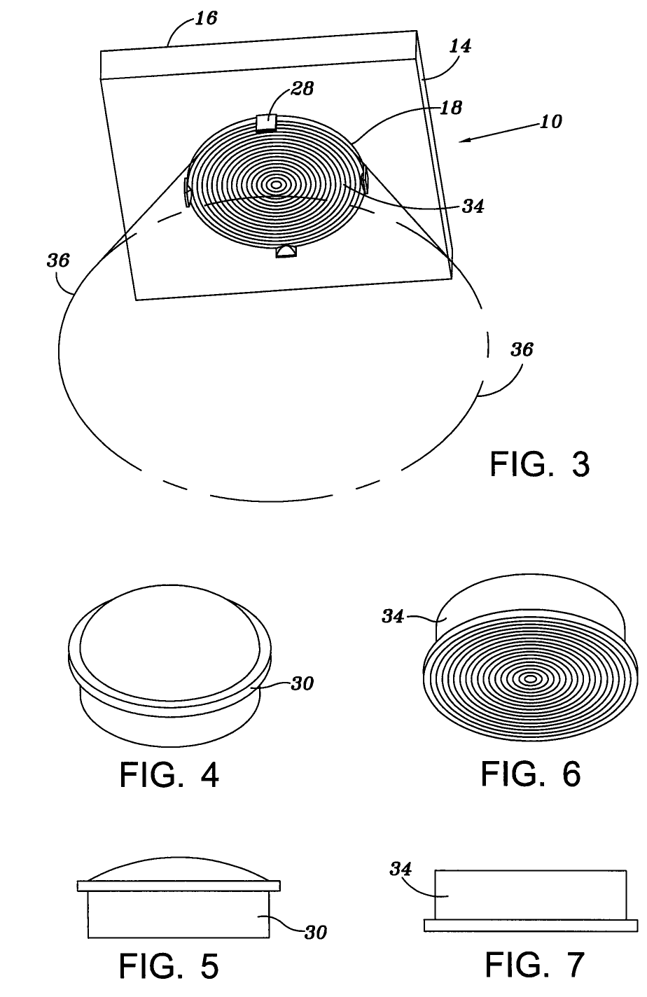

Referring simultaneously to FIGS. 2, 4 and 5, an embodiment of lens 26 is illustrated in the form of a plano-convex lens 30. Lens 30 collects ambient light impinging on top surface 16 of housing 14 and transmits the collected light to ambient light sensor 20. The transmitted light is illustrated by the ray trace of optical energy 32 which impinges upon surface 24 of ambient light sensor 20. As can be seen, the area of the optical energy 32 transmitted by lens 30 upon surface 24 is greater than the area of aperture 18 such that lens 30 distributes light energy over a larger area on ambient light sensor 20 while using a relatively small aperture within housing 14, thereby creating a inconspicuous and non-obtrusive aperture within portable electronic device 12. With the increased distribution of light energy over the surface 24 of ambient light sensor 20, the positioning of ambient light sensor 20 with respect to aperture 18 is less critical in the Z-axis.

Referring to FIGS. 3, 6 and 7, an additional lens 26 for use with the present lens assembly 10 is illustrated, and includes a Fresnel lens 34. Lens 34 generates a ray trace of optical energy 36. Fresnel lens 34 has a negative focal length and provides the necessary distribution of optical energy in a restricted Z-axis of ambient light sensor 20 mounted within housing 14. It can be seen, in a similar manner with lens 30, lens 34 creates a ray trace of optical energy 36 which is greater in area upon surface 24 than the area of aperture 18 within housing 14. Lens 34 collects ambient light impinging on housing 14 and transmits the collected light to ambient light sensor 20.

Other alteration and modification of the invention will likewise become apparent to those of ordinary skill in the art upon reading the present disclosure, and it is intended that the scope of the invention disclosed herein be limited only by the broadest interpretation of the appended claims to which the inventor is legally entitled.

I claim:

1. A lens assembly for use with an ambient light sensor, comprising:
a housing having a top surface and including an aperture, said aperture having an area;
an ambient light sensor mounted within said housing, spaced apart from said housing top surface and adjacent to said housing aperture, said ambient light sensor having a surface for receiving optical energy; and
a lens mounted within said housing aperture for collecting ambient light impinging on said housing top surface and for transmitting the collected light to said ambient light sensor surface, such that the transmitted light is distributed over an area on said ambient light sensor surface that is greater than said area of said housing aperture.

2. The assembly of claim 1 wherein said lens includes a negative focal length Fresnel lens.

3. The assembly of claim 1 wherein said lens includes a plano-convex lens.

4. The assembly of claim 1 wherein said lens is disposed within said housing aperture spaced apart from said housing top surface.

5. The assembly of claim 1 wherein said lens includes a filter.

6. The assembly of claim 1 wherein said lens includes a filter for blocking infrared wavelengths of light.
